(19) United States
(12) Patent Application Publication
(10) Pub. No.: US 2022/0333903 A1
(43) Pub. Date: Oct. 20, 2022

(54) Apparatus And Method Of Crossing A Barb Wire And Carrying Game

(71) Applicant: Robert HERDA, Hudson, WI (US)

(72) Inventors: Robert Herda, Hudson, WI (US); Dominique Pierre Aris, Rolling Hills Estate, CA (US)

(73) Assignee: Robert Herda, Hudson, WI (US)

(21) Appl. No.: 17/640,317

(22) PCT Filed: Sep. 3, 2020
(86) PCT No.: PCT/US2020/049289

§ 371 Date: Mar. 3, 2022

Related U.S. Application Data
(60) Provisional application No. 62/895,046, filed on Sep. 3, 2019.

(51) Int. Cl. F41H 11/11; A01M 31/00

(52) U.S. Cl. CPC F41H 11/11; A01M 31/006

(57) ABSTRACT

A barbed or razor wire crossing apparatus and system that enable the safe passage for a user either over or between barbed or razor wire. Also a game carrying kit that enables a hunter to field dress an animal and to prevent or greatly limit the spread or exposure of the hunted game's blood during transportation.

### PRIORITY

This application is a 371 application of PCT Patent Application No. PCT/US2020/04928, filed on Sep. 3, 2020, which claims priority to and the benefit of U.S. Provisional Application No. 62/895,046, filed on Sep. 3, 2019, which is hereby incorporated herein by reference in its entirety.

### FIELD

The present invention relates generally to apparatuses and methods of crossing a fence or barrier and carrying hunted or harvested game, more particularly, to an apparatus and method of crossing a barbed wire fence or barrier and to devices and methods of containing blood of a hunted or harvested game before and after cleaning.

### BACKGROUND

A number of devices and methods are available for crossing a barbed wire fence or barrier. These devices and method are generally either permanent structures that are built over a barbed wire fence or a temporary barrier placed between strands of the barbed wire.

Generally speaking, the permanent structures have typically consisted of stairs or ladders built of wood. These wood structures are typically double sided ladders with a platform built over the top strand of a barbed wire fence. The wood structures can be 4 feet or higher above a ground surface making a fall from them in a remote area potentially life threatening. Additionally, these wood structures are often not regularly maintained, thereby increasing the possibility of injury during use. Another problem with these permanent structures is that they are generally not portable to other locations causing a hiker or hunter to travel greater distances in order to locate a safe location to cross the barbed wire fence.

The temporary barriers have typically consisted of a flexible material such as a thick fabric or leather that is placed over the barbed wire fence to act as a shield between the barbs and the person crossing the over the wire. The problem with these temporary devices is that they are often compromised by the sharp barbs extending through or puncturing the material. This can be unpleasant for the person crossing the fence. Additionally, barbs puncturing through the material can become life threatening if the person injured is in a remote location.

A need still remains for an improved apparatus and method for crossing a fence or a barbed wire fence that is portable while also being able to effectively prevent accidental barb injuries. It is thus apparent that an apparatus and method for crossing a fence or barbed wire fence would be very desirable.

Conventional methods of carrying or transporting a hunted game often result in the spilling or leaking of the blood of the captured game. For instance, once a goose or other fowl have been hunted and cleaned, which often entails removal of the entrails and head, the blood is allowed to drain out of the carcass. The result is that the blood often runs down the back of the hunter, due to it being carried over the hunter's shoulder. If a carcass is placed into a container, such as a conventional bag, the draining blood is allowed to cover the animal's feathers and skin. This can cause additional clean up time of the animal and its hide or feathers.

A need still remains for an improved apparatus and method for containing and/or transporting the blood of a harvested or cleaned animal. It is thus apparent that an apparatus and method for containing the blood of a harvested and/or cleaned animal would be very desirable.

### SUMMARY

The present invention provides for a barbed or razor wire crossing apparatus having a rail, cover or shroud that can be placed over a barbed wire to protect the user. In an example embodiment of the invention, the shroud can be manufactured to have a length that is generally positionable parallel to and along a long axis of the barbed wire being crossed. The shroud includes a channel having a size or shape capable of receiving the barbed wire such that the barbed wire runs in and along the channel during use.

In one arrangement, the rail, cover or shroud comprises a plurality of rail, cover or shroud segments or sections that can be interconnected to permit adjustment of various features of the shroud. For instance, in one embodiment of the invention the shroud segments can be adjusted to increase or reduce its size (e.g., length, height or width). The shroud segments can be telescopically nested or foldable with respect to one or more of the shroud segments. It is also possible to include a combination of nested and foldable or pivotable shroud segments.

Another aspect of the invention is that the shroud can be selectively attached or coupled to the barbed wire to hold it in place during use. One mechanism that can be employed it the addition of one or more retaining or coupling members coupled to the shroud or shroud segments. The retaining or coupling members can be manufactured from a generally resilient material that allows it to engage and at least temporarily hold the barbed wire. In one example embodiment of the invention, the coupling members can be disposed in the channel of the shroud or shroud segments to selectively retain or hold the barbed or razor wire therein during use and to prevent the shrouds accidental separation from the wire.

Another aspect of the invention is a game or kill kit that is convenient and eliminates or greatly reduces the spread of blood from a hunted game. The game carrying kit includes a game bleed or blood bag that can be put over the neck of the hunted game after the head has been removed during field dressing. The game bleed bag includes a cinch assembly that is either fixed or removably positioned in its bag opening to cinch around a neck of a hunted game.

A compression member can also be provided that is manufactured from a blood-soaking foam or material that is able to absorb the blood of the game and prevent its escape from the game bleed bag. The compression member can be manufactured from one or more different materials. For instance, the compression member can have multiple layers with an upper or outer layer comprising a generally non-porous rubber material and an inner or lower porous material that is able to absorb blood. The inner blood absorbing layer aids is preventing blood that comes into contact possibly passing the rubber outer layer.

The above summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1A is a perspective view of a telescopic barb or razor wire crossing device and method according to an example embodiment.

FIG. 1B is a cross section view of the telescopic barb or razor wire crossing device and method according to an example embodiment.

FIG. 2A is a cross section view of a shroud segment of the telescopic barb or razor wire crossing device and method according to an example embodiment.

FIG. 2B is a cross section view of a shroud segment of the telescopic barb or razor wire crossing device and method according to an example embodiment.

FIG. 2C is a cross section view of a shroud segment of the telescopic barb or razor wire crossing device and method according to an example embodiment.

FIG. 3A is a perspective view of a retaining member of the barb or razor wire crossing device and method according to an example embodiment.

FIG. 3B is a perspective view of a retaining member of the telescopic barb or razor wire crossing device and method according to an example embodiment.

FIG. 4A is a perspective view of a telescopic barb or razor wire crossing device and method according to an example embodiment.

FIG. 4B is a cross section view of the telescopic barb or razor wire crossing device and method according to an example embodiment.

FIG. 5A is a cross section view of a rail segment or section of the telescopic barb or razor wire crossing device and method according to an example embodiment.

FIG. 5B is a cross section view of a rail segment or section of the telescopic barb or razor wire crossing device and method according to an example embodiment.

FIG. 5C is a cross section view of a rail segment or section of the telescopic barb or razor wire crossing device and method according to an example embodiment.

FIG. 6 is a perspective view of a retaining member of the barb or razor wire crossing device and method according to an example embodiment.

FIG. 7A is a perspective view of a telescopic barb or razor wire crossing device and method according to an example embodiment.

FIG. 7B is a cross section view of the telescopic barb or razor wire crossing device and method according to an example embodiment.

FIG. 8A is a cross section view of a rail segment or section of the telescopic barb or razor wire crossing device and method according to an example embodiment.

FIG. 8B is a cross section view of a rail segment or section of the telescopic barb or razor wire crossing device and method according to an example embodiment.

FIG. 8C is a cross section view of a rail segment or section of the telescopic barb or razor wire crossing device and method according to an example embodiment.

FIG. 9A is a front view of a foldable barb or razor wire crossing device and method according to an example embodiment.

FIG. 9B is a front view of the foldable barb or razor wire crossing device and method according to an example embodiment.

FIG. 9C is a front view of the foldable barb or razor wire crossing device and method according to an example embodiment.

FIG. 10A is a front view of a foldable barb or razor wire crossing device and method according to an example embodiment.

FIG. 10B is a cross section view of the foldable barb or razor wire crossing device and method according to an example embodiment.

FIG. 11A is a side view of a hinge of the foldable barb or razor wire crossing device and method according to an example embodiment.

FIG. 11B is a side view of a hinge of the foldable barb or razor wire crossing device and method according to an example embodiment.

FIG. 11C is a side view of a hinge of the foldable barb or razor wire crossing device and method according to an example embodiment.

FIGS. 12A-12C are cross section views of a telescopic portion of the foldable barb or razor wire crossing device and method according to an example embodiment.

FIGS. 12D-12E are cross section and end views, respectively, of a hinge of the foldable barb or razor wire crossing device and method according to an example embodiment.

FIG. 12F is a side view of the hinge of FIG. 12e.

FIG. 13A is a top view of a fluid container and method in an open state according to an example embodiment.

FIG. 13B is a top view of a fluid container and method in a closed state according to an example embodiment.

FIG. 13C is a top view of a constrictor and fluid absorbent member and method according to an example embodiment.

FIGS. 14A and 14B are side and top views, respectively, of a securing member and method according to an example embodiment.

FIGS. 15A and 15B are side and top views, respectively, of a securing member and method according to an example embodiment.

FIG. 16 is a perspective view of fluid absorbent member and method according to an example embodiment.

FIG. 17 is a top view of a fluid container and method in a closed state according to an example embodiment.

FIGS. 18A and 18B are front and perspective views, respectively, of a method of closing a fluid container according to an example embodiment.

FIG. 19 is an exploded view of a constrictor or fluid absorbent member and fluid container according to an example embodiment.

FIG. 20A is a perspective view of a fluid container and method according to an example embodiment.

FIG. 20B is a perspective view of a fluid container and method according to an example embodiment.

FIG. 20C is a perspective view of a fluid container and method according to an example embodiment.

FIG. 21A is a side view of a securing member of a fluid container and method according to an example embodiment.

FIG. 21B is a top view of a securing member of a fluid container and method according to an example embodiment.

FIG. 21C is a top view of a securing member of a fluid container and method according to an example embodiment.

FIGS. 22A and 22B are perspective views of a securing member of a fluid container and method according to an example embodiment.

FIGS. 23A and 23B are perspective views of a securing member of a fluid container and method according to an example embodiment.

FIG. 24 is a perspective view of securing members attached to various wrist technologies according to an example embodiment.

FIG. 25 is a perspective view of a securing member of a fluid container and method according to an example embodiment.

FIGS. 26A-26E are illustrations of a hunted game transporting kit according to an example embodiment.

FIG. 27A is a perspective view of a retractable barb or razor wire crossing device and method according to an example embodiment.

FIG. 27B is a cross sectional view along line B-B of FIG. 27A of a retractable barb or razor wire crossing device and method according to an example embodiment.

FIG. 28A is a front cross sectional view along line A-A of FIG. 27A of a retractable barb or razor wire crossing device and method according to an example embodiment.

FIG. 28B is a cross sectional view along line B-B of FIG. 27A of a retractable barb or razor wire crossing device and method according to an example embodiment.

FIG. 29 is a top cross sectional view of a retractable barb or razor wire crossing device and method according to an example embodiment.

FIG. 30 is a bottom cross sectional view of a retractable barb or razor wire crossing device and method according to an example embodiment.

FIG. 31 is a longitudinal cross sectional view of a retractable barb or razor wire crossing device and method according to an example embodiment.

FIG. 32 is an exploded view of a retractable barb or razor wire crossing device and method according to an example embodiment.

FIG. 33 is a perspective view of a barbed wire crossing apparatus and method.

FIG. 34 is a perspective end view of a barbed wire crossing apparatus and method. Illustrating a coupling member.

FIG. 35 is a longitudinal cross section view of a barbed wire crossing apparatus and method illustrating example locations of coupling members.

FIG. 36 is a partial exploded view of a barbed wire crossing apparatus and method illustrating detents and carriers.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

Dimensions and relative proportions of components are merely example embodiments and can be varied unless specifically limited in a given claim. Thus, the dimensions can be varied without departing from the scope of the invention.

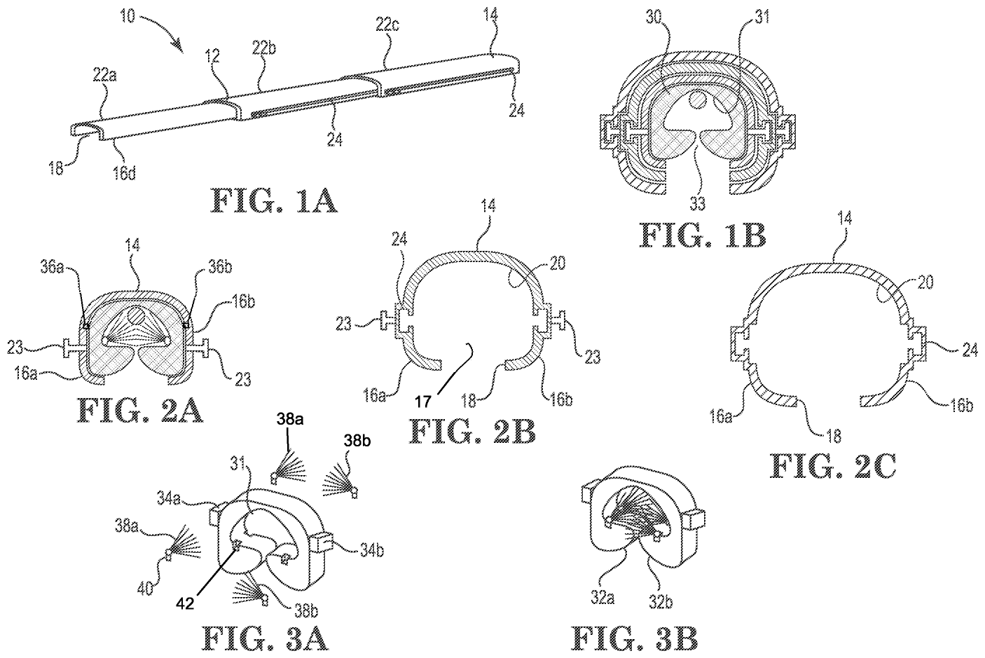

The present invention of a barbed or razor wire crossing apparatus and method 10 is illustrated in the accompanied Figures. An example embodiment, illustrated in FIGS. 1A and 1B, comprises a length of a shroud, cover, or rail 12. The shroud, cover, or rail 12 comprises a shield portion or surface 14 and a pair of spaced apart side surfaces or portions 16a and 16b. The shroud, cover, or rail 12 generally comprises a rigid or semi-rigid material. However, any material may be utilized provided it acts as a barrier between a user and the barbs or razor of the wire being crossed.

As particularly illustrated in FIG. 1B and FIGS. 2A-2C, the spaced apart side surfaces or portions 16a and 16b define a channel 17, comprising an opening or entrance 18 and an interior 20 of the shroud 12. The opening 18 is sized and shaped to permit the passage of a barbed wire into the channel 17 during use. The shroud, cover, or rail 12 may be manufactured with different sized channels 17, openings 18 and interiors 20 to accommodate different sizes or types of barbed or razor wire. The channel 17, opening 18 and interior 20 of the rail 12 generally runs an entire length of the shroud 12.

The side portions 16a and 16b of the shroud 12 can have a generally uniform or varying length or height in order to provide additional protection in some areas of the shroud 12 while reducing material weight in other areas of the shroud 12. An outer surface of the top portion 14 and side portions 16a and 16b of the shroud 12 can be generally uniform or smooth. In another embodiment of the invention, the outer surface of the top portion 14 or side portions 16a and 16b of the shroud 12 can be generally uneven or textured to increase gripping or handling by a user. Various combinations of texturing and surface modifications or variations are also possible and should be considered to be within the spirit and scope of the invention.

In another example embodiment of the invention, it is advantageous to have a compact or compactable barbed or razor wire crossing apparatus 10 while hiking or for storage purposes. As illustrated in FIGS. 1A-2C, the barbed or razor wire crossing apparatus 10 can comprise a plurality of interconnected shroud or rail sections or segments 22a, 22b and 22c. The shroud segments 22a, 22b, and 22c are able to operatively communicate with each other in various ways in order to reduce or change the size of the barbed or razor wire crossing apparatus 10.

One embodiment of the invention, includes shroud segments 22a, 22b, 22c that are nested together and telescopically positionable between a retracted position and an extended position. As particularly illustrated in FIGS. 2A-2C, the shroud segments 22a, 22b, and 22c may be manufactured having different sized crossed sections (i.e., width and height). As illustrated in FIG. 1B, having different sized cross sections enables the shroud segments 22a, 22b, and 22c to longitudinally slide within each other, thereby reducing the overall length of the shroud 12 to a length approximately equal to the longest segment 22a, 22b, and 22c. While three segments are described herein it is contemplated that more or less sections can be utilized.

The shroud segments 22a, 22b, and 22c can be interconnected in such a way to guide their telescoping or nesting within each other. As illustrated in FIG. 1A, one or more of the shroud segments or sections 22a, 22b, and 22c can have one or more outwardly extending post or screws 23. The posts or screws 23 may travel along a channel or slot 24 formed in an adjacent shroud segment 22a, 22b, and 22c. The post 23 can be manufactured as part of the shroud segments 22a, 22b, and 22c or may be a component that is, for instance, screwed or secured to the shroud segment 22a, 22b, or 22c.

As illustrated in FIGS. 2A and 2B, the side portions 16a and 16b of the shroud segment 22a each have an outwardly extending post 23. The posts 23 of the shroud segment 22a are matable with opposed slots 24 of the shroud segment 22b. Similarly, the posts 23 extending from the side portions 16a and 16b of the shroud segment 22b are matable with the opposed slots 24 of the shroud segment 22c. The slots 24 of the shroud segments 22b and 22c extend along at least a portion of a length of the shroud segments 22b and 22c such that shroud segments 22a, 22b, and 22c are able to telescope or nest within or over each other.

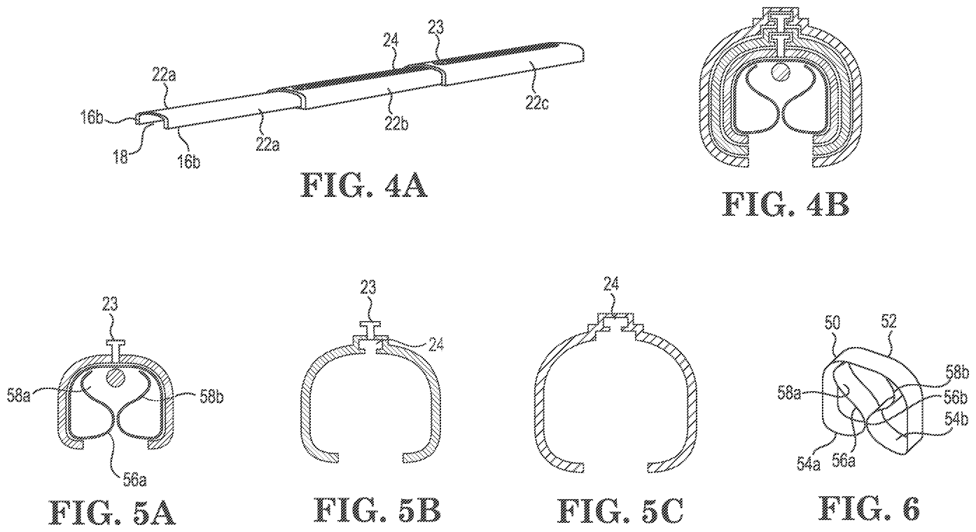

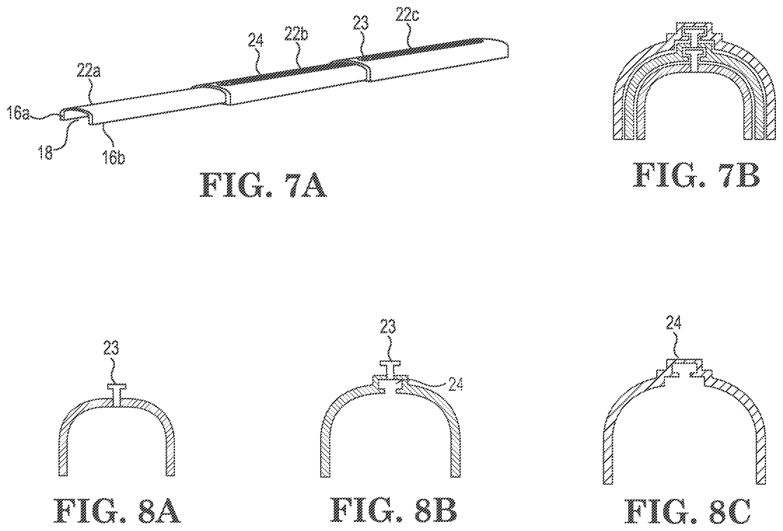

The positons of the posts 23 and slots 24 in the side portions 16a and 16b of the shroud segments 22a, 22b, and 22c may vary by embodiments or within a particular embodiment. For instance, as illustrated in FIGS. 4A-8C, the posts 23 and the slots 24 are positioned on a top portion 14 of the shroud segments 22a, 22b, and 22c.

In order to prevent accidental separation of the shroud 12 once it is placed on the barbed wire, one or more retaining or coupling members 30 may be permanently or removably positioned within the channel 17 or interior 20 of the shroud 12 or shroud segments 22a, 22b, and 22c. The coupling members 30 can be manufactured of any material able to generally withstand the damage caused by the barbs or razors of the wire that it retains. For example, the coupling members 30 may be manufactured from rubber, plastic, or a generally compressible or resilient material such as a foam rubber.

Referring to FIGS. 1B, 3A and 3B, the coupling member 30 can have an outer shape adapted to mate with or conform generally to an inner surface of the channel 17 or interior 20 of the shroud 12 or shroud segments 22a, 22b, and 22c. The coupling member 30 can include a cavity or space 31 that is sized or shaped to receive and retain the barbed or razor wire. Referring to FIG. 3B, the coupling member 30 can also include a pair of lip members or portions 32a and 32b that extend in a direction generally toward each other and form a slit 33 that extends into the cavity 31. The lip portions 32a and 32b may have generally rounded outer or lower surface that aid in directing the barbed or razor wire through the slit 33 and into the cavity 31.

The coupling member 30 can have a length or thickness equal to or less than a length of the shroud 12 or any of the shroud segments 22a, 22b, and 22c. It is also possible to have a coupling member 30 at each end of the shroud 12 or spaced along a length of the shroud 12. In the collapsible embodiment of the present invention, there can be a coupling member 30 for each shroud segment 22a, 22b, and 22c or a plurality of coupling members 30 within each shroud segment 22a, 22b, and 22c. Any number or sizes of coupling members 30 is contemplated herein.

A feature of an embodiment of the invention is that the coupling member 30 can be removed or replaced in the event that it becomes damaged during use. As illustrated in FIGS. 2A, 3A and 3B, the coupling member 30 can have one or more nubs or protuberances 34a and 34b that extend outwardly or away therefrom and into a channel or notch 36a and 36b formed in an inner surface of the shroud 12 or shroud segments 22a, 22b, and 22c. In the event that a coupling member 30 is damaged and needs to be replaced, a user may simply pinch the coupling member 30 with their fingers or a tool and then squeeze and/or rotate the coupling member 30 within the shroud 12 or shroud segments 22a, 22b, and 22c to dislodge the protuberances 34a and 34b from the notches 36a and 36b. A new coupling member 30 can be reinserted into the shroud 12 or the shroud segments 22a, 22b, and 22c by reversing the removal process or steps.

The coupling member 30 can also include one or more wire stabilizers or retainers 38a and 38b positioned in the interior or adjacent thereto that act to retain or further retain the wire within the cavity 31 of the coupling member 30 or within the apparatus 10. The wire stabilizers 38a and 38b can comprise any shape or configuration that is able to retain or hold onto the barbed wire. For example, the stabilizers can comprise one or more wire engagement portions such as bristles, flaps, ribs, or the like that extend into the cavity 31 from one or more portions or parts of the coupling member 30. The stabilizers 38a and 38b are adapted to operatively engage with and reduce the movement of the barbed wire within the cavity 31 or to prevent it from moving out of the cavity 31.

The bristles of the wire stabilizers 38a and 38b can extend from one or more attachment members or posts 40 that can be removably matable with or fixed in a notch or hole 42 extending into a portion of the coupling member 30. Similar to the coupling members 30, the wire stabilizers 38a and 38b can be replaced in the event they become damaged during use. In some embodiments of the invention, the coupling members 30 and stabilizers 38a and 38b can have different sizes, shapes, and configurations for different uses. For example, crossing barbed wire of different sizes or different types of protective wire or fencing.

In another example embodiment of the invention, a foam or other compressible material can be operatively disposed in the shroud 12. The compressible material is able to engage or receive the barbed wire and prevent its exit from the channel 17 of the shroud 12. The compressible material is also capable of preventing separation of the shroud 12 from the barbed wire. It is also contemplated herein that the apparatus 10 can include a combination of bristle and compressible wire stabilizers 38a and 38b.

Referring to FIG. 4A through FIG. 6, the coupling member 30 can also comprise a retaining clip 50 having an outer support section 52 that can have a shape generally conformable to an inner surface of the shroud 12 or the shroud segments 22a, 22b, and 22c. The retaining clip 50 can also have a pair of inwardly extending arm sections or portions 54a and 54b, each of which includes a slit section or portion 56a and 56b that are proximate to or touching each other. The retaining clip 50 can also include one or more retaining sections or portions 58a and 58b that extend away from the slit sections 56a and 56b and generally toward an inner surface of the outer support section 52. The slit sections 56a and 56b form a slit through which a barbed wire is passed into and out of the clip retaining sections 58a and 58b. The barbed wire is retained within the retainer sections 58a and 58b. In one example embodiment, the retaining sections 58a and 58b can each have one or more wire stabilizers operatively coupled to it in order to further limit movement of the wire.

The shroud 12 or shroud segments 22a, 22b, and 22c can have a combination of coupling members 30 and clips 50 along its length.

The cross sectional shape of the shroud 12 or shroud segments 22a, 22b, and 22c can vary and, as illustrated, may have a generally C-shape, oblong C-shape, or U-shape. Other cross sectional shapes are also contemplated herein, including but not limited to a V-shape, square-shape, rectangular-shape, and any other shape that is able to receive and at least temporarily retain a barb or razor wire.

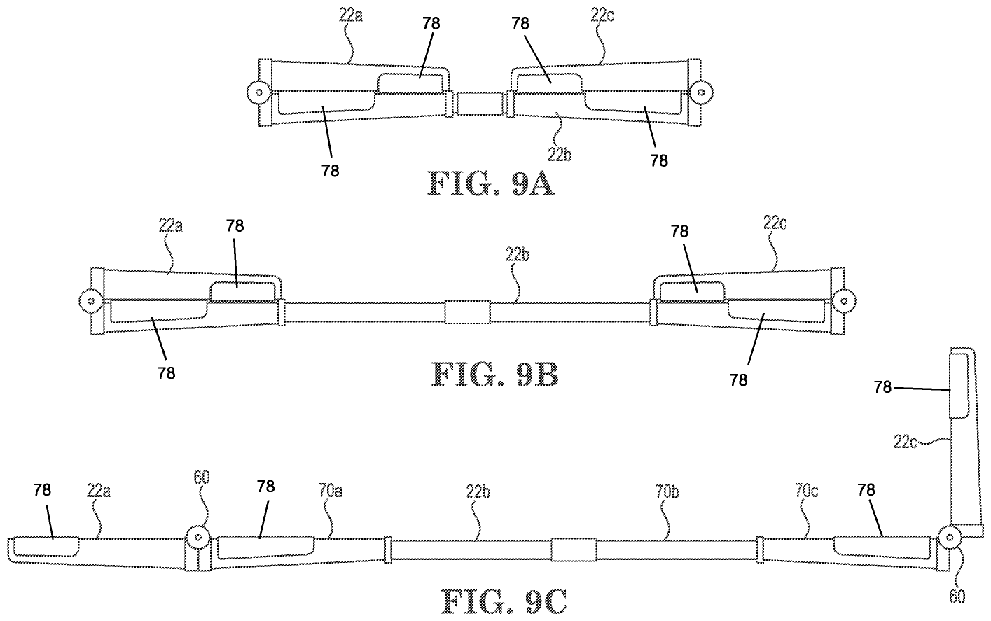

In another example embodiment of the invention, as illustrated in FIGS. 9A-9C, the shroud segments 22a, 22b, and 22c can be interconnected such that they can be folded to reduce its overall length. Shroud segments 22a and 22c can be hingedly coupled to opposed ends or portions of shroud segment 22b. The length of each shroud segment 22a and 22c may be generally half of the length of shroud segment 22b in order to reduce the overall length of the shroud 12 to the length of shroud segment 22b. Any length and number of segments may be employed to reduce the overall length of the shroud 12.

A hinge or pivoting mechanism 60 can be used to allow the shroud segments 22a, 22b, and 22c to rotate or pivot with respect to each other. The hinge 60 may comprise any known hinge type, including but not limited to a butt hinge, piano hinge, butterfly hinge, flush hinge, spring hinge, or living hinge. Other hinge or pivot mechanisms are also contemplated herein and should be considered to be within the spirit and scope of the present invention.

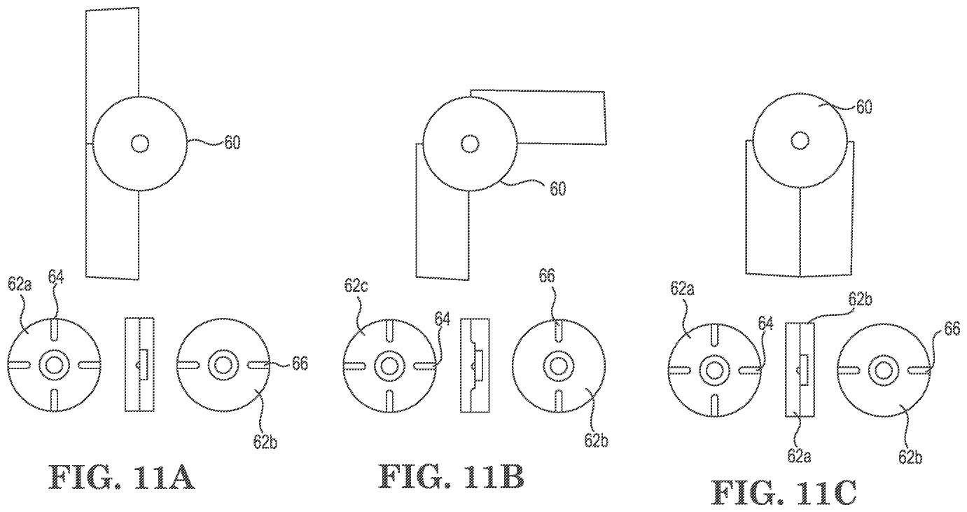

In one embodiment of the present invention, the hinge 60 is adjustable or rotatable such that the shroud segments 22a, 22b, and 22c can be oriented or positioned, and at least temporarily held at varying angles. As particularly illustrated in FIGS. 11A-11C, the adjustable hinge 60 comprises a first hinge portion 62a and second hinge portion 62b that are operatively mated together. The first hinge portion 62a can have one or more spaced-apart recesses 64 that extend into a mating surface and are positioned about its circumference. The second hinge portion 62b includes one or more ribs 66 that extend away from a mating surface and are removably positionable within the recesses 64 when the mating surfaces are in contact with each other. Various sizes and shapes of bosses and detents, and saddles and catches, are possible and should be considered to be within the spirit and scope of the invention.

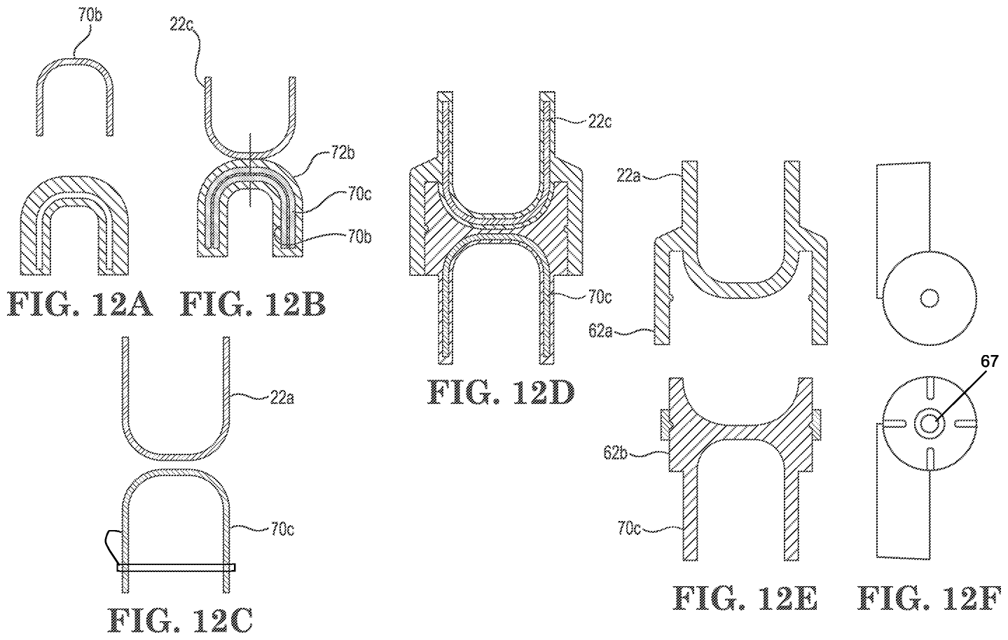

There can be one or more hinges 60 for each shroud segment 22a, 22b, and 22c. For instance, as illustrated in FIGS. 12D-12F, shroud segment 22b can have hinge portion 62b formed or fixed on one or more of its side surfaces while shroud segment 22a includes one or more corresponding and matable hinge portions 62a formed in or fixed to one or more of its side surfaces. As particularly illustrated in FIG. 12E, the hinge portions 62a can be in the form of a tab that extends away from shroud segment 22a and is generally flexible to allow it to move or flex slightly when mating with the hinge portion 62b on the other shroud segment (see FIG. 12E).

The hinges 60 can be pressure fitted so that rotation of the hinge 60 requires an amount of force by a user to unseat the ribs 66 from the recesses 64. It is also possible to have a release button that is operatively coupled in the hinge 60 such that pressing the release button 67 causes hinge portion 62a to move away from hinge portion 62b, thereby unseating the ribs 66 and allowing rotation of the hinge 60.

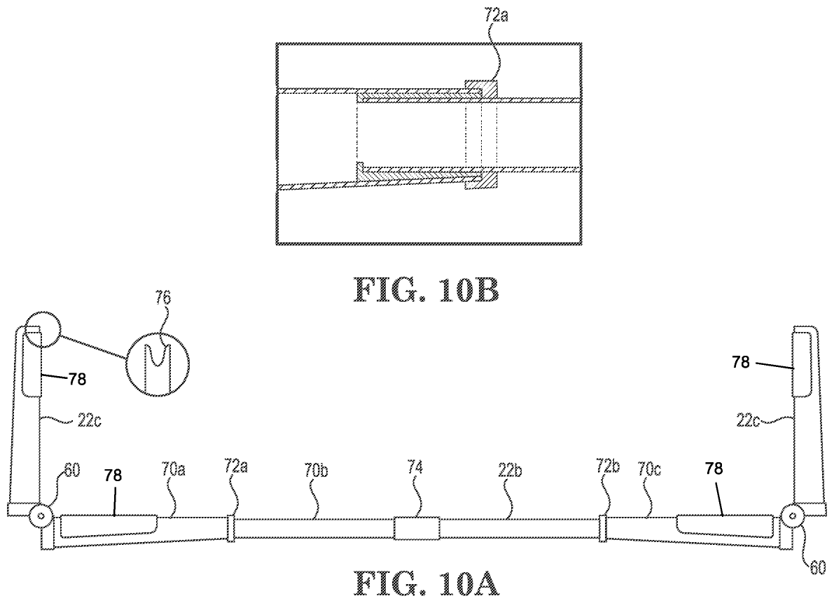

As illustrated in FIGS. 10A and 12B, shroud segment 22b may include a plurality of sub-shroud segments or sections 70a, 70b, and 70c that are telescopic or nested with respect to each other. The sub-shroud segments 70a, 70b, and 70c allow a user to reduce and expand a length of the shroud 12. Any number of sub-shroud segments may be used to allow for reduction of the overall length of the shroud 12.

In one example embodiment of the invention, stops 72a and 72b may be disposed in ends of sub-shroud segments 70a and 70c, respectively. Ends of sub-shroud segment or section 70b are operatively disposed in the stops 72a and 72b. The stops 72a and 72b function as a track in which the sub-shroud segments 70a and 70c travel along a length of sub-shroud segment or section 70b. The sub-shroud segment 70c also includes a sub-shroud stop 74 operatively disposed on an outer surface that stops movement of the sub-shroud segments 70a and 70c as they travel from an extended position toward a retracted position.

Similar to other embodiments described herein, the cross sectional shape of the shroud 12, shroud segments 22a, 22b, and 22c and sub-shroud segments 70a, 70b, and 70c can vary and may have a generally C-shape, oblong C-shape, or U-shape. Other cross sectional shapes are also contemplated herein, including but not limited to a V-shape, Square-shape, Rectangular-shape, and any other shape that is able to receive and at least temporarily retain a barbed or razor wire. It is also contemplated herein that shroud segments or sub-shroud segments may be composed of different cross sectional shapes for different portions of the shroud 12. For instance, shroud segment 22b and its sub-shroud segments 70a-70c can have a generally U-shape cross section and the shroud segments 22a and 22c can have a generally C-shape cross section.

As particularly illustrated in FIG. 10A, ends of the shroud 12 or shroud segments 22a and 22c can have a barbed or razor catch 76 that is able to receive a barb or razor formed on the wire. The catch 76 is adapted to engage the barb or razor wire and to assist in preventing rotation of the shroud 12 about the wire. In one example embodiment of the invention, the barb or razor catch 76 comprises a notch or some other type of recess formed in the ends of the shroud 12 or shroud segments 22a and 22c. A barb or razor catch 76 can also be coupled to an end of the shroud or shroud segments 22a and 22c. The barb or razor catch 76 may comprise any shape or configuration that aids in preventing rotation about or accidental separation of the shroud 12 or shroud segments 22a and 22c from the wire.

The shroud 12 or shroud segments 22a and 22c can have one or more pads 78 disposed on their outer surface to be gripped by a user or to add additional protection between the user and the barb or razor wire. The pads 78 may be manufactured from any material such as rubber or foam. The pads 78 may also be formed into the outer surface of the shroud 12 and shroud segments 22a and 22c. The pads 78 may have a textured outer surface to aid in gripping by a user.

In one example embodiment, the shroud 12 or shroud segments 22a, 22b, and 22c and/or the coupling members 30 or stabilizers 38a and 38b may be manufactured from various materials for different purposes. For instance, one or more of the parts apparatus 10 can be manufactured from an electrically insulating or nonconductive material. This would enable a user to cross electrified wire fences.

In use, multiple barb or razor wire shroud, cover or rails 12 may be employed. For instance, a user having to pass between a pair of spaced apart barbed or razor wires can place a shroud 12 on one of the wires that will be stepped over and another rail on a wire that will be above the user. In this way, a user is able to protect their legs, hands, chest and back when going between the two wires. The coupling members 30 act to retain the wire and prevent separation of the shroud 12, even when in an inverted orientation or position.

The present invention also includes a game carrying kit 100 that is convenient and eliminates or greatly reduces the spread of blood from a hunted game. The game carrying kit includes a game bleed or blood bag 102 that can be put over the neck of the hunted game after the head has been removed during field dressing. The game bleed bag 102 includes a cinch assembly 104 that is either fixed or removably positioned in its bag opening to cinch around a neck of a hunted game.

The cinch assembly 104 comprises a compression member 106 having an opening 108 extending through it that is sized and shaped to receive the neck of the hunted game. The cinch assembly 104 also includes a cinch 120 that extends about the compression member 106 to cause the compression member 106 to move from an uncompressed state to a compressed state. Once a hunted game's neck has been inserted into the opening 108 the cinch 120 can be tightened around the compression member, which reduces the size of the opening 108 about the neck of the hunted game. Blood from the neck of the hunted game is then captured in the bag.

In one embodiment of the present invention, the compression member 106 includes one or more slits 110 extending through it that form compression struts 112a, 112b, and 112c that extend around the opening 108. The slits 110 and the compression struts 112a, 112b, and 112c permit a uniform circumferential compression of the compression member 106 as it moves from the uncompressed state toward the compressed state.

The compression member 106 can be manufactured from any material such as a foam, batting or a rubber material. Any material able to act as a barrier and that prevents the passage of blood out of the game bleed bag 102 may be used and should be considered to be within the spirit and scope of the invention.

The compression member 106 can also be manufactured from a blood-soaking foam or material that is able to absorb the blood of the game and prevent its escape from the game bleed bag 102. The compression member 106 can also be manufactured from one or more different materials. For instance, the compression member 106 can have multiple layers with an upper or outer layer comprising a generally non-porous rubber material and an inner or lower porous material that is able to absorb blood. The inner blood absorbing layer aids is preventing blood that comes into contact possibly passing the rubber outer layer.

In another example embodiment of the invention, the compression member 106 is placed between two layers of material such as two layers of the blood bag 102. An inner layer of the blood bag 102 can have a plurality of openings 107 that expose the compression member 106 to the surface of the animal being carried. In the event that blood from flows through the opening or mouth of the blood bag 102, it will flow into the openings 107 and be absorbed by the compression member 106.

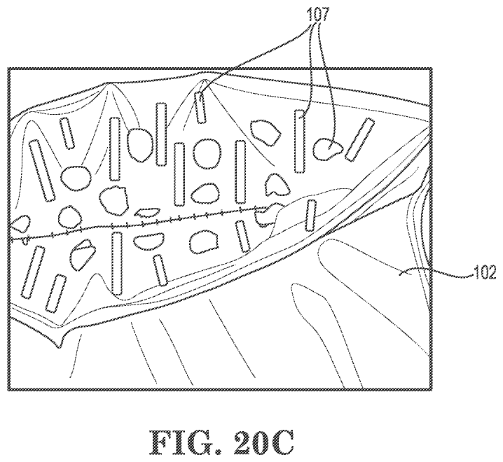

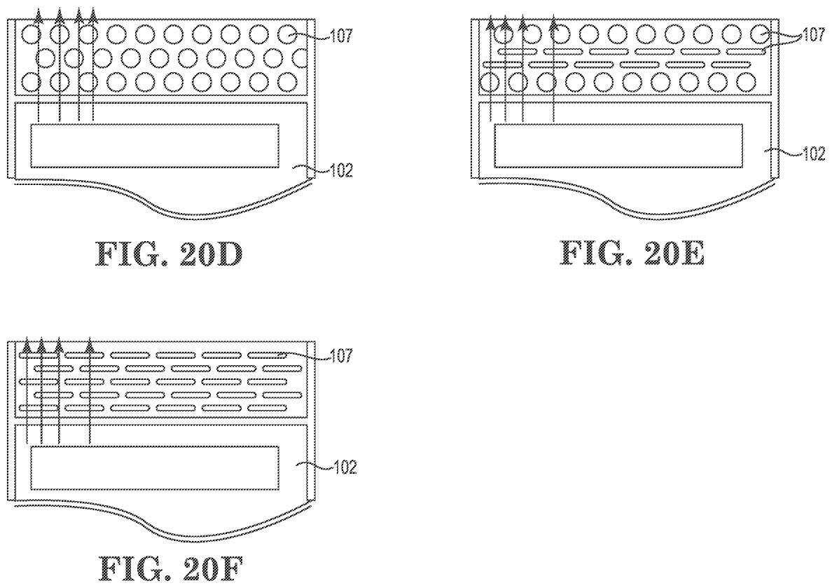

As illustrated in FIGS. 20C-20F, the openings 107 may comprise a plurality of holes or slits. The holes or slits can be orientated in such a way that a flow of blood through a mouth of the blood bag 102 is directed through the holes or slits and into contact with the absorbable compression member 106. It is also contemplated herein, the compression member 106 can comprise only an absorbent material that is capable of absorbing blood or other fluids without providing any or little compressive force.

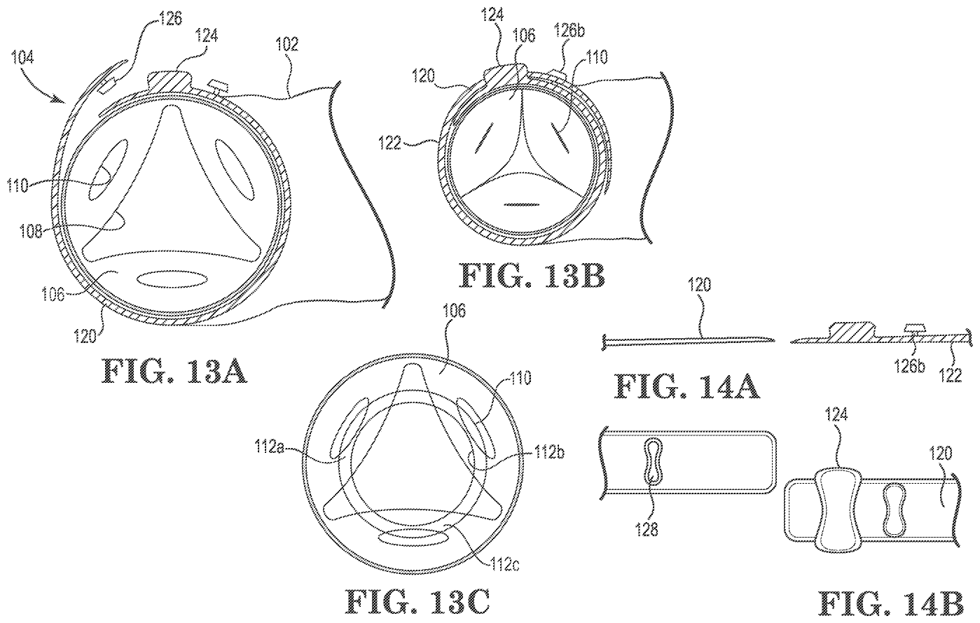

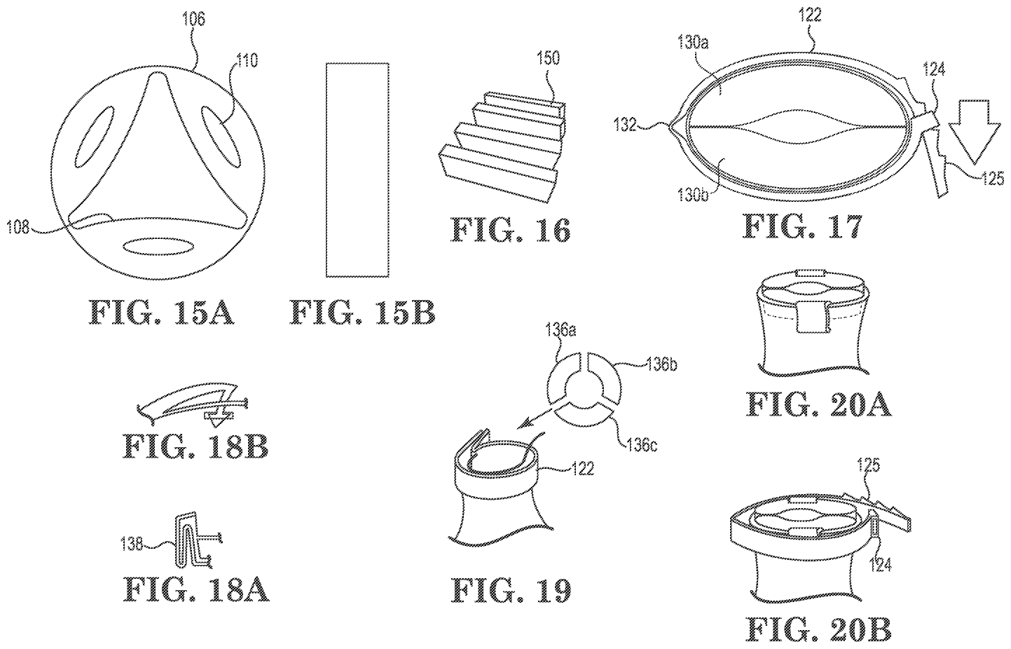

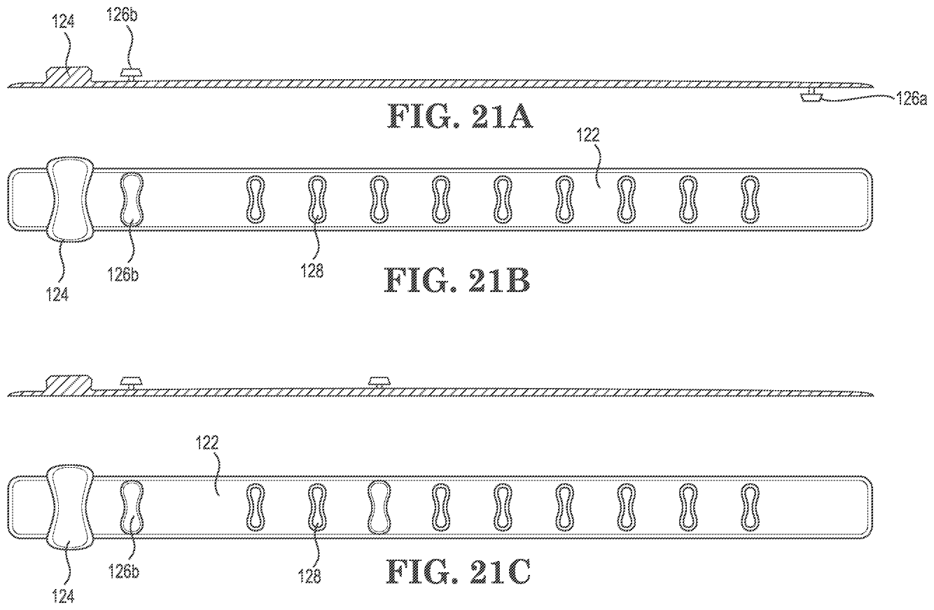

The cinch 120 can comprise any configuration and material able to extend about a circumference of the compression member 106. As illustrated in FIGS. 13A-14B, the cinch 120 can comprise a strap 122 having a length that is able to extend about the compression member 106. A guide or loop 124 is formed on an outer surface of the strap 122 to receive a free end portion wrapped around the compression member 106. The cinch 120 can be secured in a compression state by inserting one or more posts 126a and 126b extending from an inner surface and/or outer surface of the strap 122 into one or more holes 128 extending through the strap 122. As illustrated in FIGS. 21A-21C, a series of holes 128 can be spaced apart along a length of the strap 122 to permit a user to adjust the compressive force on the compression member 106.

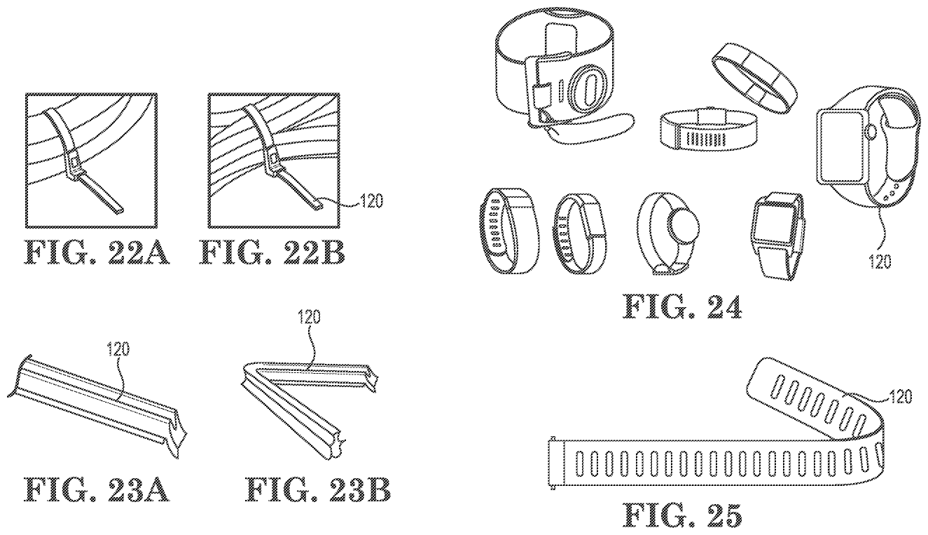

As illustrated in FIGS. 22A-25, the cinch 120 can comprise any configuration. For instance, the cinch 120 of the present invention can be coupled to a watch and act as a watchband. This configuration allows a user to have ready access to a cinch 120 in the event a game is successfully hunted. The user is able to detach the cinch 120 from the watch and secure its watch ends to create a length of cinch that can extend about the compression member 106. Once the game is transported and removed from the game bleed bag 102 the user can then wash and reattach the cinch 120 to their watch. The cinch 120 can also be removably attached to a watch band or to any clothing for ready access while hunting.

The cinch 120 can also be worn about the wrist of a user similar. In this configuration, the cinch 120 acts as a bracelet that provide ready access to a user while also eliminating the need to take up space in the users backpack or totes. The cinch 120 can have any type of indica. For instance, it can display a logo or trademark. The style and design of the cinch 120 enables it to be worn by user all the time and providing a user the ability to cinch or tie anything or any material quickly and easily.

Other cinch assemblies 104 are also possible. As illustrated in FIGS. 17-20C, the compression member 106 can have one or more lobe portions 130a and 130b that form the hole 108 for receiving the neck of the hunted game. The strap 122 can also have one or more ridges such that when the strap 122 is inserted through the loop 124 the ridges 125 are able to engage the loop 124 and prevent separation of the strap 122 from the loop 124. The strap 122 can also have a living hinge portion 132 that enables the strap 122 to close in generally a clam-shape configuration. This closure configuration enables the cinch 120 to close against the lobes 132a and 132b of the compression member 106 and compress or restrict the size of the hole 108, thereby securing the game bleed bag 102 to the neck of the hunted game.

As illustrated in FIGS. 18A-19, the compression member 106 can comprise a plurality of generally arcuate compression segments 136a, 13b and 136c that when assembled create the hole 108 for receiving the neck of the hunted game. In this embodiment, the cinch 120 comprises a foldable strap 122 having a hook portion 138 that is insertable into the loop or guide 124 formed in the side of the strap 122. As the strap 122 is folded around the compression segments 136a, 13b and 136c they are squeezed together thereby restricting the size of the hole 108 and securing the game bleed bag 102 to the neck of the hunted game.

The game bleed bag 102 can have the compression member 106 secured to the inner surface of the bag by an adhesive or other securing means. Alternatively, as illustrated in FIGS. 20A and 20B, one or more clips 140a and 140b can be used to secure the compression member 106 to the mouth of the bag. One end of the clips 140a and 140b can be inserted into a slot formed in the compression member 106 with the other end extending over an outer surface of the compression member 106. The mouth of the bag can then be inserted between an end of the clip and the compression member 106. The cinch 120 can then be placed about the compression member 106 and tightened to move the compression member 106 from the uncompressed state to the compressed state.

The game carrying kit 100 can also include one or more absorbent members 150 that can be placed into the game bleed bag 102 to absorb any blood that flows into the bag. The absorbent members 150, as illustrated in FIG. 16 can be individual pieces of absorbent material. Depending upon the size of the hunted animal a hunter is able to select the amount or number of absorbent members 150 needed to ensure that the blood does not flow out of the bag. The absorbent members 150 can have any size or shape and the foregoing description should not be considered limiting.

The game carrying kit 100 can also include a game body bag 160 that has a body portion 162 having an opening for placing the hunted animal into the game body bag 160. The game body bag 160 can also include a tapered neck portion 164 adapted to receive the neck of the hunted animal. A handle 166 on one or more sides of the opening enable a hunter to carry the game body bag in such a manner that the hunted animal or game remains inverted with the neck in the neck portion 164 of the bag 160. Additionally, any blood will also accumulate in the neck portion 164 of the game body bag 160.

A head bag 170 can also be included in the kit 100. The head bag 170 has an opening that permits a hunter to place the head bag 170 over the head of the game. A cinch 120 can be placed around the opening of the head bag 170 to secure the bag to the neck of the hunted game. If the head is removed from the hunted game it can also be placed into the head bag 170 for later inspection by a game official. The head bag 170 can also act as a blood bag to be placed over the neck after the head has been removed, if needed, during field dressing. The cinch 120 can be placed around the neck to secure the bag in place.

The game body bag 160 and the head bag 170 can each hold absorbent members 150 that are able to absorb any blood flowing from the hunted game.

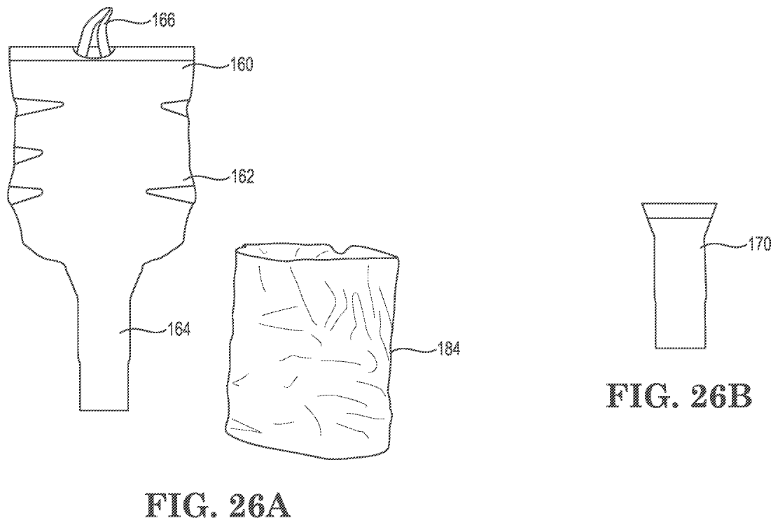

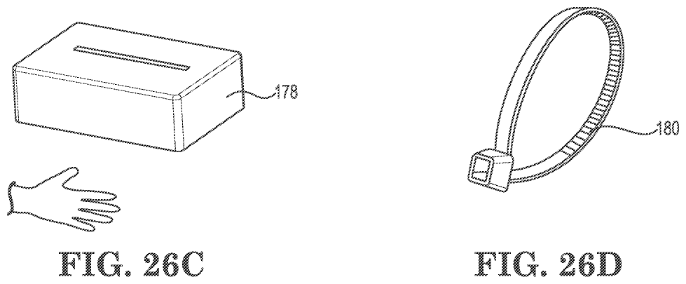

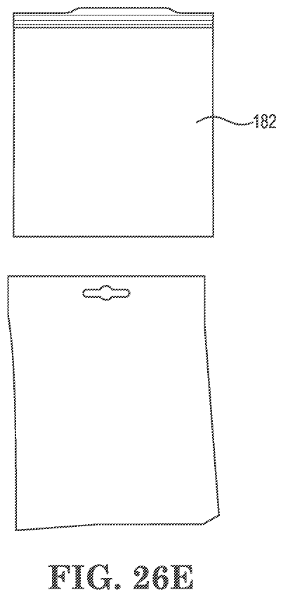

As illustrated in FIGS. 26E-26E, the game carrying kit 100 can also include gloves 178 for limiting the exposure of the hunter to blood borne pathogens, zip ties 180 to close the bags of the kit 100 and various other bags such as freezer bags 182 and compost bags 184 that can be used for packaging the game for freezing or for composting the hunted game.

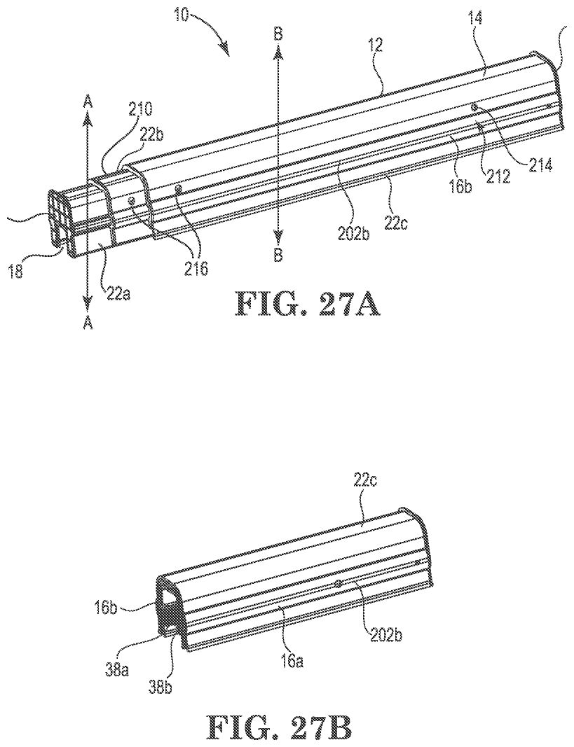

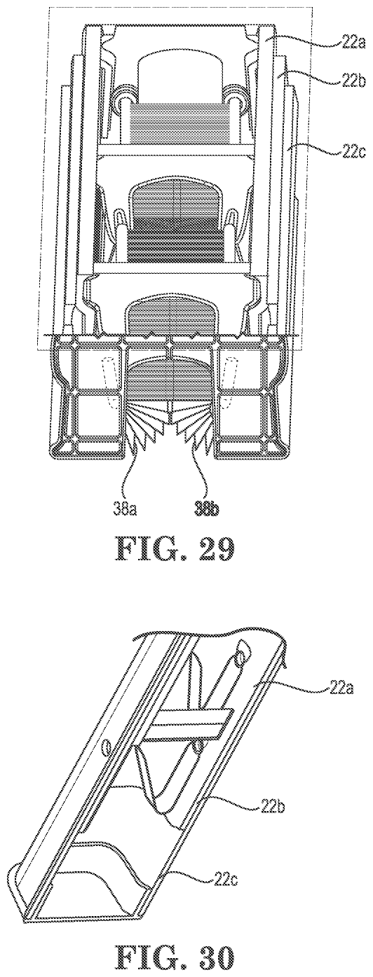

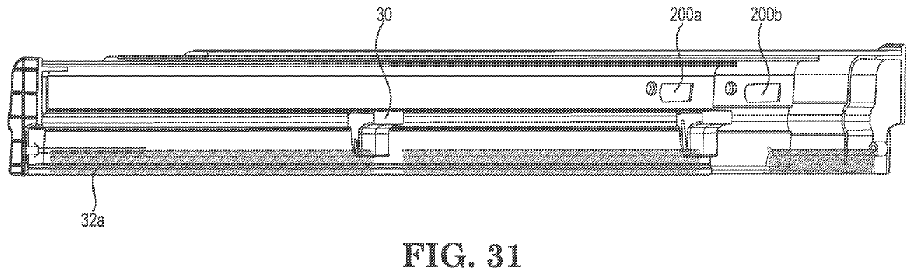

In yet another example embodiment of the present invention of a barb or razor wire crossing apparatus and method 10 is illustrated FIGS. 27A-32. Similarly to other disclosed embodiments, the apparatus 10 comprises a length of a shroud, cover, or rail 12. The shroud 12 comprises a shield portion or surface 14 and a pair of spaced apart side surfaces or portions 16a and 16b.

The barbed or razor wire crossing apparatus 10 of FIGS. 27A-32 can also comprise a plurality of interconnected shroud segments 22a, 22b and 22c. The shroud segments 22a, 22b, and 22c are able to operatively communicate with each other in various ways in order to reduce the size of the barbed or razor wire crossing apparatus 10 to at least a length of one of the rail sections or segments 22a, 22b, and 22c.

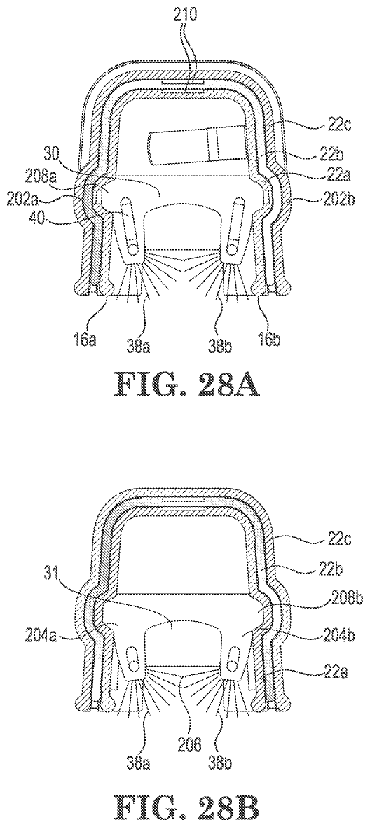

As illustrated in FIGS. 28A, 30, and 31, retention members 200a and 200b are mounted or connected to an inner surface of section 22b and 22c respectively to operatively engage with and to at least temporarily retain the shroud segments 22a, 22b and 22c nested together. For instance, when section 22a slides into section 22b it will engage retention member 200a as it slides back. Similarly, as section 22b slides back into section 22c it will engage retention member 200b. The retention members 200a and 200b can retain the sections by engagement with a portion of the sections or by a friction fit. Any operative engagement that enables selective retention of the sections in either a collapsed or retracted state may be utilized. It is also possible to use the retention members 200a and 200b or other retention members to temporarily retain the sections 22a-22c in an extended state.

Similar to other embodiments, the shroud segments 22a, 22b, and 22c may be manufactured having different sized crossed sections that enable them to longitudinally slide within each other, thereby reducing the overall length of the shroud 12 to a length generally approximate to or equal to the longest segment 22a, 22b, and 22c.

As illustrated in FIGS. 27A-28B, one or more of the shroud segments 22a, 22b, and 22c have one or more outwardly extending longitudinally extending ribs, channels, or recesses 202a and 202b. The varying cross sectional sizes of the shroud segments 22a-22c, enable the ribs 202a and 202b to travel within each other when moving between the extended state and a retracted state. The nesting of the ribs 202a and 202b prevent separation or un-nesting of shroud segments 22a-22c.

In one example embodiment of the invention, the coupling member 30 may be permanently or removably positioned within and extending between the longitudinally extending ribs 202a and 202b. Referring to FIGS. 28A and 28Bm, the coupling member 30 can have an outer shape adapted to mate with or conform generally to an inner surface of the channel 17 or interior 20 of the shroud 12 or shroud segments 22a, 22b, and 22c. The coupling member 30 can include a cavity 31 that is adapted to receive and retain the barbed or razor wire. The coupling member 30 can also include a pair of downwardly extending legs 204a and 204b that form a slit or opening 206 that extends into the cavity 31.

The coupling members 30 may be positioned along a length of shroud segment 22a. Additionally, coupling members 30 may also be placed proximate to an end of shroud segment 22c to retain wire entering at that end of the apparatus. The coupling members 30 in shroud segment 22c may also act as a stop to prevent complete nesting of shroud segments 22a and 22b into shroud segment 22c. There may also be coupling members 30 positioned in shroud segment 22b that receive wire entering near a middle or center of the apparatus 10. The coupling member 30 positioned in shroud segment 22b may act as a stop that prevents shroud segment 22a from completely nesting within shroud segment 22b. In the collapsible embodiment of the present invention, there can be a coupling member 30 for each shroud segment 22a, 22b, and 22c or a plurality of coupling members 30 within each shroud segment 22a, 22b, and 22c. Any number or sizes of coupling members 30 is contemplated herein.

In one example embodiment of the present invention and as particularly illustrated in FIG. 27a, slide members 210 can be placed on the top or upper surface 14 of the shroud 12. The slide members 210 extend along at least a portion of a length of shroud segments 22a-22c. Each slide member 210 abuts a lower surface of an adjacent shroud segments 22a-22c. The slide member 210 reduces the friction between the slide member 210 and an adjacent shroud segments 22a-22c, thereby enabling it to be operated quietly.

The apparatus 10 of the present invention can be manufactured from material that enables it to operate quietly. For instance, the all or some of its parts can be manufactured from Delrin or a similar material. The apparatus 10 can also be coated with a material that enables its parts, in particular sections 22a-22c, to operate smoothly and quietly.

Additionally, as illustrated in FIG. 27a, the shroud segments 22a-22c can be kept in place by a locking mechanism 212 that is able to selectively lock the apparatus in a particular or desired length. The locking mechanism 212 can comprise a depressible button or detent 214 that can be depressed by a user when adjusting a length of the shroud 12. As the shroud 12 is adjusted the button 214 is able to slide behind a surface of one of the shroud segments 22a-22c until a bias member operatively coupled to the button 214 biases the button into a hole or recess 216 in a shroud segments 22a-22c, thereby at least temporarily locking it in place or position.

Similar to other embodiments disclosed herein the coupling member 30 can be removed in the event that it becomes damaged during use. As illustrated in FIGS. 28A and 28B, the coupling member 30 can have one or more nubs or protuberances 208a and 208b that extend outwardly therefrom and into ribs 202a and 202b, respectively. In the event that a coupling member 30 is damaged and needs to be replaced, a user may simply pinch the coupling member 30 with their fingers and then squeeze and/or rotation the retaining member 30 within the rail 12 or shroud segments 22a, 22b, and 22c to dislodge it and reinsert a new one into the shroud 12 or the shroud segments 22a, 22b, and 22c.

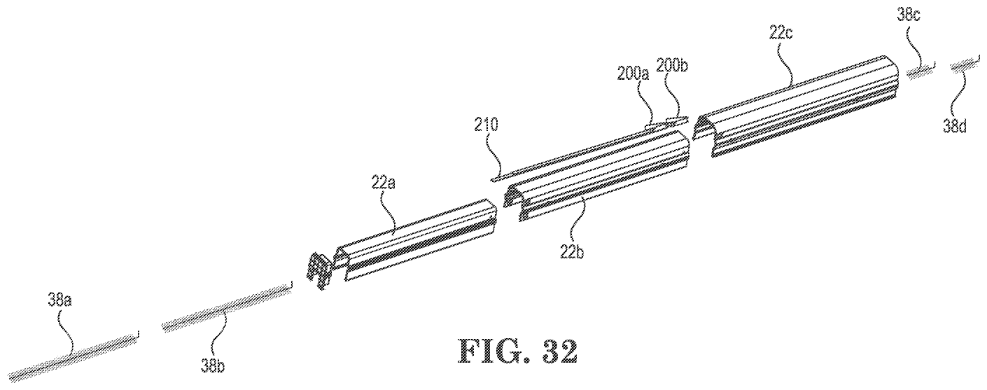

The wire stabilizers 38a and 38b can be connected to an elongate support member that can be removably insertable into a notch 42 formed in the legs 204a or 204b. The support member may comprise an elongate rod with the plurality of bristles, ribs, flaps, or other members extending into the cavity 31. Similar to the retaining members 30, the wire stabilizers 38a and 38b can be replaced in the event they become damaged during use. As illustrated in FIG. 32, end wire stabilizers 38c and 38d may be removably positionable in retaining members 30 disposed in section 22c. The end wire stabilizers 38c and 38d can similarly be replaced in the event they become damaged. End caps can be provided to protect the ends of the wire stabilizers 38a and 38b. The end caps may include a notch formed therein that is able to receive the barbed or razor wire and allow it to pass through the opening and become positioned in the interior.

The coupling member 30 can be manufactured having a size and shape that prevents the barbed or razor wire from contacting the surface of the shroud 12. By reducing or preventing contact between the shroud 12 and the barbed or razor wire noise created by the two coming into contact is reduced or eliminated. The coupling member 30 can be manufactured from any material that aids in reducing or eliminating any noise generated between it and the barbed or razor wire. For instance, a rubber material, Ethylene Propylene Diene Monomer rubber or any other similar type material can be utilized. It is also contemplated herein that a similar noise dampening or eliminating material can be applied to an inner surface of the shroud 12 or any of its components.

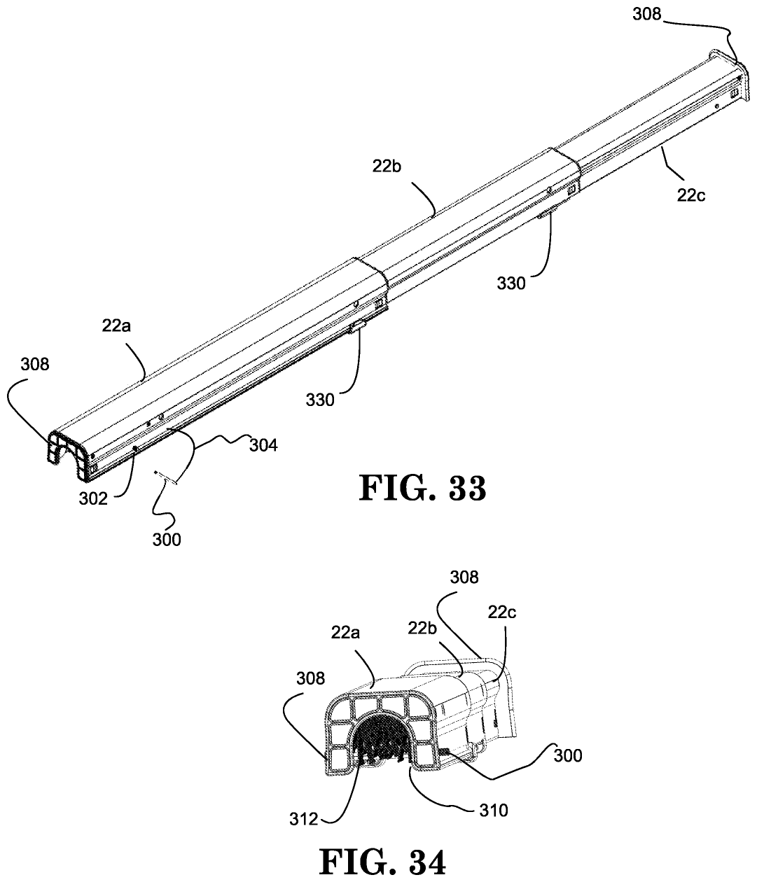

In another example embodiment of the invention, as illustrated in FIGS. 33-36, the shroud 12 or shroud segments 22a, 22b, and 22c, are able to be secured, at least temporarily, to the barbed wire by a securing member 300 such as a pin that is able to slide through or be inserted into aligned holes 302 extending through a portion of the shroud 12 or shroud segments 22a, 22b, and 22c. There can be any number of securing members 300 along the length of the shroud 12 or shroud segments 22a, 22b, and 22c. In one embodiment, the securing member 300 may comprise a generally rotating mechanism that can rotate over the opening 18 of the shroud 12 or shroud segments 22a, 22b, and 22c. Another feature includes having one or more of the shroud segments 22a, 22b, and 22c, or a portion thereof, rotate along its long access to secure the shroud 12 to the barbed wire.

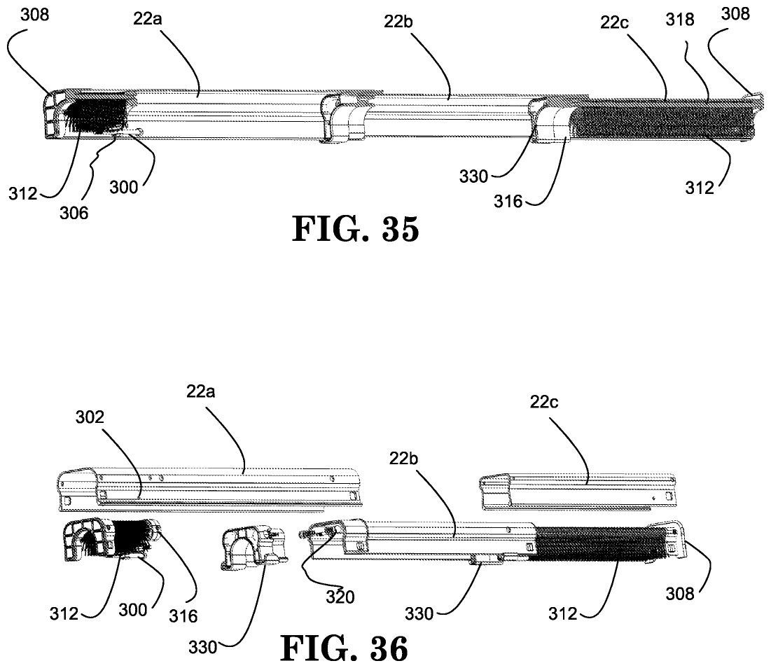

The securing member can be connected or tethered to the shroud 12 to prevent it from becoming lost in the field. In one embodiment, as illustrated in FIG. 33, a tether 304, such as a flexible cable or strand, can extend between and be coupled to a portion of the shroud 12 and the securing member 300. In another example embodiment, as illustrated in FIG. 35, a catch 306 can be coupled to or formed on a portion of the shroud 12 or shroud segments 22a, 22b, and 22c to hold the securing member 300 when not being used. As particularly illustrated in FIG. 35, the catch can comprise a clip or any other type of holding mechanism.

The shroud 12 or shroud segments 22a, 22b, and 22c can also include end walls, caps or surfaces 308 having notches 310 formed therein that are aligned with the channel 17. As described above, the notches 310 receive the barbed wire when the shroud 12 or shroud segments 22a, 22b, and 22c are placed on the barbed wire. The notches 310 permit the barbed wire to be positioned deeper into the channel 17 and allow more of the shroud 12 to extend around and below the barbed wire. As particularly illustrated in FIGS. 34 and 35, the end walls 308 can have a generally greater height or width than the shroud 12 and shroud segments 22a, 22b, and 22c to prevent a user's hand from slipping onto the barbed wire.

The coupling members 312 that are capable of engaging and holding onto the barbed wire can be secured or held by carriers 316 that are disposed in the channel 17 of the shroud and shroud segments 22a, 22b, and 22c. The carriers 316 are designed to receive and support a portion of the coupling members 312 such as a stem or spine 318 containing a number of bristles or barbed wire engaging members or portions. The spines 318 of the coupling members 312 can be removably seated in a portion of the carriers 316 so that they can be replaced. The coupling members 312 can be assembled in the channel 17 of the shroud 12 or shroud segments 22a, 22b, and 22c in varying configurations. For example, there can single, pair or multiple coupling members 312 running along a length of the shroud 12 or shroud segments 22a, 22b, and 22c extend.

As can be seen in FIG. 36, detents 320 can be operatively coupled in the shroud 12 or shroud segments 22a, 22b, and 22c to maintain a retracted or extended position of the shroud 12 and shroud segments 22a, 22b, and 22c. The detents 320 can include an engagement portion that extends out of holes or openings in the shroud 12 and shroud segments 22a, 22b, and 22c to selectively secure the desired position. A biasing member, such as a spring, can be operatively coupled to the engagement portion to maintain the detents 320 in the desired position or orientation. When a user wants to change the position or orientation, they can depress the detent 320 against the biasing member which will cause the shroud 12 or shroud segments 22a, 22b, and 22c to become movable.

The present invention can also include guides 330 that are disposed in the channel 17 and coupled to a portion of the shroud 12 or shroud segments 22a, 22b, and 22c. The guides 330 include slide portions that are sized and shaped to receive a portion of the shroud 12 or shroud segments 22a, 22b, and 22c. In one example embodiment, the guides 330 include a one or more curved feet portions that support the shroud 12 or shroud segments 22a, 22b, and 22c. It is also a proposed feature that the guides 330 are manufactured from a material that reduces or eliminates any sound that would or could be created during operation of the apparatus 10.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

What is claimed is:

1. An apparatus for crossing a fence having at least one wire, the apparatus comprising:
an elongate shroud having a channel extending along its length; and
at least one coupling member mounted in the channel to selectively couple the shroud to the at least one wire of the fence such that the shroud acts as a shield to protect a user while crossing the at least one wire of the fence.

2. The apparatus of claim 1, wherein the shroud further has generally opposed end walls, each of the end walls having a notch extending therein that are aligned with at least a portion of the channel of the shroud.

3. The apparatus of claim 2, wherein at least one of the end walls have a height that is generally greater than a height of the shroud such that it prevents a hand of a user from sliding off the shroud during use.

4. The apparatus of claim 2, wherein at least one of the end walls have a width that is generally greater than a width of the shroud such that it prevents a hand of a user from sliding off the shroud during use.

5. The apparatus of claim 1, wherein the at least one coupling member has one or more bristle portions capable of releasably retaining a wire of a fence.

6. The apparatus of claim 5, wherein the one or more bristle portions extend away from at least one connector portion that is removably connectable to an interior surface of the shroud.

7. The apparatus of claim 1, wherein the at least one coupling member extends along at least a portion of a length of the shroud.

8. The apparatus of claim 1, further comprising at least one securing member extending through at least a portion of the shroud to selectively close at least a portion of the channel and prevent the shroud from separating from a wire of a fence.

9. The apparatus of claim 8, wherein the at least securing member comprises a pin.

10. The apparatus of claim 8, wherein the shroud further comprises a holding member that is capable of releasably holding the securing member when not being used.

11. The apparatus of claim 10, wherein the holding member comprises a clip.

12. The apparatus of claim 1, wherein the elongate shroud comprises a plurality of nested shroud segments each having a channel extending along its length with at least one shroud segment being telescopically movable between an extended position and a retracted position.

13. The apparatus of claim 12, further comprising at least one stop member being disposed on at least one of the shroud segments to stop the shroud segments from separating in the extended position.

14. The apparatus of claim 13, wherein the at least one stop member further comprises an engagement portion that engages a portion of an adjacent shroud segment to selectively secure the shroud segments in the extended position such that the engagement portion is selectable to allow movement from the extended position to retracted position.

15. A barbed wire shielding apparatus, the apparatus comprising:
an elongate shroud having a channel extending along its length; and
at least one coupling member disposed in at least a portion of the channel to selectively couple the shroud to the barbed wire such that the shroud acts as a shield to protect a user while traversing the barbed wire.

16. The shielding apparatus of claim 15, wherein the elongate shroud comprises a plurality of interconnected shroud segments each having a channel extending along its length.

17. The shielding apparatus of claim 16, wherein at least one of the shroud segments is telescopically interconnected such that it is movable between an extended position and a retracted position.

18. The shielding apparatus of claim 16, wherein at least one of the shroud segments is pivotally interconnected such that it is movable between a folded position and an unfolded position

19. The shielding apparatus of claim 15, further comprising at least one guard portion extending from the shroud such that the guard portion prevents a hand of user from the barbed wire.

20. The shielding apparatus of claim 15, wherein the at least one coupling member comprises a resilient material capable of forming around at least a portion of the barbed wire during use.
